(19) United States
(12) Patent Application Publication
(10) Pub. No.: US 2025/0153360 A1
(43) Pub. Date: May 15, 2025

(54) METHOD AND APPARATUS FOR AUTOMATED COORDINATION OF THE ACTIVITIES OF A PLURALITY OF ROBOTS

(71) Applicant: VOLKSWAGEN AKTIENGESELLSCHAFT, Wolfsburg (DE)

(72) Inventor: Eric Roslin WETE POAKA, Wolfsburg (DE)

(21) Appl. No.: 18/839,531

(22) PCT Filed: Jan. 13, 2023
(86) PCT No.: PCT/EP2023/050734

§ 371 Date: Aug. 19, 2024

(30) Foreign Application Priority Data
Feb. 21, 2022 (DE) 10 2022 201 792.7

(51) Int. Cl. B25J 9/16

(52) U.S. Cl. CPC B25J 9/1682; B25J 9/1661

(57) ABSTRACT

A method for automated coordination of the activities of a plurality of robots that perform activities as a group in a common robot cell, scheduled tasks of the robots of the common robot cell are detected, with dependencies existing among the tasks. The scheduled tasks are assigned to individual robots of the common robot cell during the operation of the common robot cell. Instructions for the execution of the scheduled tasks are transmitted to the individual robots of the common robot cell. During the execution of the tasks, the robot cell state is recorded. The execution of the tasks not yet is optimised during the operation of the common robot cell, taking into account the current robot cell state and the dependencies existing among the tasks.

### PRIORITY CLAIM

This patent application is a U.S. National Phase of International Patent Application No. PCT/EP2023/050734, filed 13 Jan. 2023, which claims priority to German Patent Application No. 10 2022 201 792.7, filed 21 Feb. 2022, the disclosures of which are incorporated herein by reference in their entireties.

### SUMMARY

Illustrative embodiments relate to a method for the automated coordination of the activities of a plurality of robots, which can be used, for example, in multi-robot cells for production systems in car body construction, and to an apparatus for carrying out the method.

### BRIEF DESCRIPTION OF THE DRAWINGS

Disclosed embodiments will be described in more detail below with reference to drawings, in which:

FIG. 1 shows a flow chart of a disclosed method;

FIG. 2 shows a schematic representation of a multi-robot cell with two robots; and

FIG. 3 schematically shows the execution of various tasks by the robots of FIG. 2, with FIG. 3(A) according to the prior art and FIG. 3(B) according to the disclosed method.

### DETAILED DESCRIPTION

Due to the versatility and flexibility of industrial robots, they are widely used today, particularly in manufacturing, and perform a variety of tasks. This flexibility can be used, for example, to produce options of the same component or even different components in the same robot cell, which corresponds to the working area for an industrial robot.

In a multi-robot cell, different operations can be carried out simultaneously on a component by a group of a plurality of robots. By programming the multi-robot cell or the robots in the multi-robot cell, the operations are distributed among the robots so that the total time required to process a component is minimized, taking into account that the robots in the group do not collide with each other or with the component. Even though multi-robot cells are usually digitally controlled in production, they are still usually programmed manually. This is an error-prone and time-consuming task. Furthermore, problems can occur during the operation of the multi-robot cell in production, for example, due to a fault at one of the robots such as the failure of a robot tool or a task that cannot be completed by the robot for other reasons. Such unexpected events are difficult to take into account during programming.

If a problem occurs with a robot in the shared multi-robot cell, this can lead to the other robots in the shared multi-robot cell also being unable to continue their activities until the fault has been rectified. This can lead to a longer production standstill, particularly if a robot needs to be repaired, and thus to a reduction in productivity and a corresponding increase in production costs. In the case of larger and more expensive robots that perform complex tasks, this can lead to a significant time delay, especially if no suitable replacement robot is available for such cases. In addition, the greater the number of robots in the multi-robot cell working together on a component, the greater the probability that one of these robots will malfunction.

U.S. Pat. No. 11,110,606 B2 discloses a method for coordinating robots within a multi-robot cell formed by a group of robots which jointly perform work on a component. If it is determined that a robot within the group is unable to continue work on the component at a first location, the robot is removed from the group while other robots in the group continue the work. A functioning robot is then added to the group, which then starts work on the component at a second location. This allows the robots to continue working on the part according to a predetermined schedule, reducing downtime and minimizing the effort required to check for collision avoidance.

The disclosed embodiments provide an improved method for coordinating the activities of a plurality of robots, which carry out activities as a group in a common robot cell, as well as a corresponding apparatus.

In accordance with disclosed embodiments for the automated coordination of the activities of a plurality of robots, which carry out activities as a group in a common robot cell, scheduled tasks of the robots of the common robot cell are detected, wherein dependencies exist among the tasks. The scheduled tasks are assigned to individual robots of the common robot cell during operation of the common robot cell. Instructions for the execution of the scheduled tasks are transmitted to the individual robots of the common robot cell. The robot cell state is recorded during the execution of the tasks. The execution of tasks that have not yet been executed is optimised during the operation of the common robot cell, taking into account the current robot cell state and the dependencies existing among the tasks.

This increases the flexibility of planning, programming and execution of tasks during operation of the common robot cell and further optimises the processing of tasks in the common robot cell. Furthermore, this enables production systems with multi-robot cells to be operated as autonomously and self-adaptively as possible.

According to an exemplary embodiment, at least one of the tasks can be performed by a plurality of robots of the common robot cell, wherein a task originally assigned to a first robot of the common robot cell is assigned to a second robot of the common robot cell as part of the optimisation of the execution of the tasks not yet performed.

This task reallocation during operation can further increase the productivity of production systems with multi-robot cells. A reduction in energy consumption can also be achieved if necessary.

In particular, in the event that a fault of the first robot is identified that results in the first robot being unable to perform an assigned task, a robot of the common robot cell that is suitable for taking over the execution of the task assigned to the first robot can be selected as the second robot, and the task can be performed by the second robot.

In this way, a production plant with a multi-robot cell can continue to operate even in the event of a disruption, thus minimizing the risk of a production stoppage and reducing downtimes in the event of a disruption.

In particular, in the method, the robot cell state for the robots of the common robot cell can in each case comprise the current position of the robot or of grippers, tools or other production the robot, the current task, the last task processed and/or the current operating state.

Wherein taking these parameters into account, the task transfer can be adapted particularly well to the common robot cell and the robots in this common robot cell.

The current operating state of a robot can indicate in particular whether this robot is currently free, is executing an assigned task, has a fault or is under repair.

This makes it possible to adapt the reallocation to the respective operating states of the various robots in the common robot cell and to prevent the task from being assigned to a robot that is currently unsuitable for executing the task.

Furthermore, a current state can be recorded for each task, indicating whether the task is currently being processed, has been completed or not yet completed.

This makes it possible to optimise the reallocation during operation, also with regard to the tasks assigned to the robot cell.

Furthermore, the time required wherein the individual robots to complete the various tasks during operation of the common robot cell can be recorded and/or how often and under what conditions faults occur, wherein the assignment of tasks to individual robots in the common robot cell is adjusted accordingly.

This kind of learning process allows the reallocation in the operation to be further optimised over time.

Based on the faults detected, it is also possible to predict when a robot is likely to malfunction in the future, wherein the assignment of tasks is adjusted accordingly.

This makes it possible to react to potential disruptions at an early stage and, if necessary, to reallocate tasks before such a disruption occurs.

Similarly, in one exemplary embodiment, a task planning unit may transmit robot control code with instructions for executing scheduled tasks to the robots of the common robot cell by wireless radio transmission and transmit data on the robot cell state to the task planning unit by wireless radio transmission.

This ensures the greatest possible flexibility in communication with the individual robots of the common robot cell, which is particularly beneficial in the case of robot cells comprise a large number of robots or in the case of conversions of the robot cell. An apparatus for the automated coordination of the activities of a plurality of robots which carry out activities as a group in a common robot cell detects scheduled tasks of the robots in the common robot cell, wherein dependencies exist among the tasks, assigns the scheduled tasks to individual robots of the common robot cell during the operation of the common robot cell, transmits instructions for executing the scheduled tasks to the individual robots of the common robot cell, records the robot cell state during the execution of the tasks, and optimizes the execution of tasks not yet performed during operation of the common robot cell, taking into account the current robot cell state and the dependencies existing among the tasks.

Disclosed embodiments further comprise a computer program with instructions that cause an apparatus to carry out the operations of the disclosed method.

Lastly, the disclosed embodiments also comprises a multi-robot cell and a production plant with at least one multi-robot cell, which is set up to carry out a method disclosed or has an apparatus.

For a better understanding of the principles of the present exemplary embodiments are explained in greater detail below with reference to the figures. It is understood that the disclosed embodiment is not limited to these exemplary embodiments and that the features described may also be combined or modified without departing from the scope of protection of the disclosed embodiment as defined in the claims.

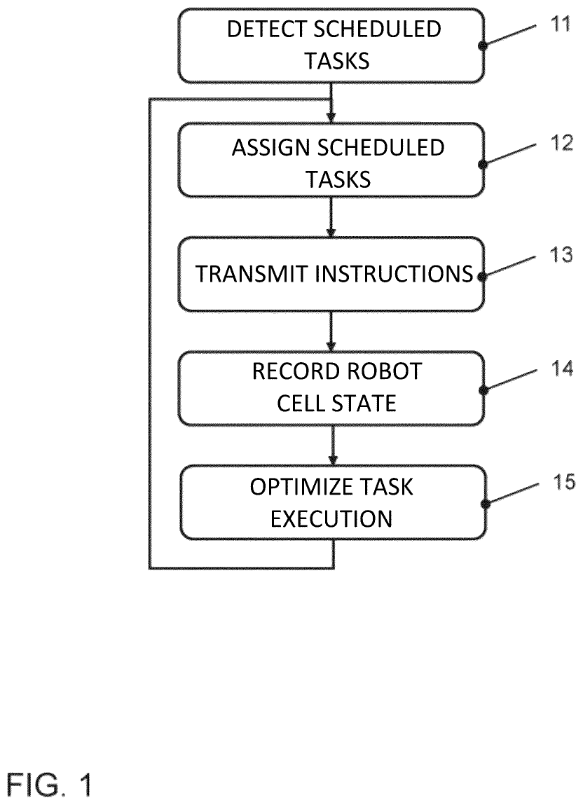

FIG. 1 shows a flow chart of a disclosed method. The method can be used, for example, for the automated coordination of the activities of a plurality of robots in a spot-welding robot cell in automotive production, but is not limited to this.

In a method operation 11, the scheduled tasks that are to be performed by the robots in a common robot cell are detected. In the case dependencies exist among the individual tasks. These can consist, for example, of the fact that the respective robot or tools, grippers or other production the robot must assume the same position for different processing operations and therefore collisions must be avoided by path planning. Another example of such dependencies is that a processing operation of a workpiece can only take place after a previous processing operation has been completed. It is also possible, for example, that a robot A cannot perform task X while robot B is performing task Y, but conversely it is possible for robot A to perform task Y while robot B is performing task X.

In a method operation 12, the scheduled tasks are then assigned to the common robot cell. In particular, robot paths are planned automatically and efficiently. Based on the image of the common robot cell and the tasks to be performed, optimum robot paths of the various robots are calculated for this purpose and robot programs are generated accordingly, wherein route length, time and energy consumption can be used as optimisation criteria, among other things, to which different priorities can also be assigned.

Robot tasks are not entered here by assigning them to an individual robot in the common robot cell. Rather, the accessibility and feasibility for the various robots are first checked for each task and, based on this, a suitable algorithm is used to determine which task should ideally be performed by which of the various robots. In particular, it is also determined which tasks can be carried out by a plurality of robots in the common robot cell. In addition, the travel times of the various robots are recorded and combinations of tasks that could lead to a collision are identified. For this purpose, offline data can be pre-calculated with a 3D model, which indicates for a large number of simulated movements if a collision would occur during a movement, in order to eliminate such movements leading to collisions by adapting the robot trajectories.

The scheduled tasks are only assigned to individual robots in the common robot cell during operation of the common robot cell. For this purpose, a unit for automatic task planning can calculate the best possible assignments of the individual tasks to the robots of the common robot cell on the basis of suitable artificial intelligence methods and models of the recorded travel times. For example, the unit for automatic task planning can be trained using reinforcement learning or Q-learning with the aid of machine learning algorithms. Furthermore, the current state of the common robot cell is permanently monitored in order to automatically identify and react to faults, for example.

In the subsequent method operation 13, instructions for executing the scheduled tasks are then transmitted to the individual robots in the common robot cell. This can be done in particular by wireless communication. For example, wireless technologies according to a WLAN or BLUETOOTH® standard or a mobile radio standard, for example, of the fourth or fifth generation (abbreviated to 4G or 5G), can be used for this purpose. Communication protocols such as OPC UA (“Open Platform Communications Unified Architecture”) or from the IIOT area (“Industrial Internet of Things”) can be used for data exchange.

In method operation 14, the current robot cell state is then recorded during the execution of the various tasks. For this purpose, various data, such as a fault, the current position of the various robots or the status of a task, can also be transmitted to the unit for automatic task planning via wireless communication. The data can be detected here by the respective robots themselves and made available via interfaces or also detected and analyzed by additional sensors, such as one or more 3D cameras in combination with suitable image processing and evaluation.

On this basis, during operation of the common robot cell in method operation 15, the execution of the tasks that have not yet been performed is optimised, taking into account the current robot cell state and the dependencies existing among the tasks.

The robot cell state can include various parameters for the robots in the common robot cell, such as, in particular, the current position of the robot or of tools, grippers or other production equipment of the robot, the current task, the last task completed and/or the current operating state. In particular, the current operating state of a robot can indicate whether the robot is currently free, is performing an assigned task, has a fault or is being repaired. Furthermore, the robot cell state contains information for the tasks assigned to the robot cell, in particular the current status, which indicates whether the task is currently being processed, has been completed or not yet completed by the robot cell.

The automatic task planning unit can react to unexpected events that are identified by analysing the transmitted data. For example, if a robot in the common robot cell malfunctions, the most suitable robot can be selected to take over a task from the malfunctioning robot and the task can be assigned to the robot. If there are only two robots in the common robot cell, it is only necessary to check whether the other robot can take over the task of the faulty robot. If, on the other hand, there are more than two robots in the common robot cell, the task may also be taken over by more than one other robot. In this case, it is then determined which of the other robots can minimise the cycle time loss when taking over the task. In this case, it is also possible to distribute a plurality of tasks assigned to the faulty robot to a plurality of other functional robots in the common robot cell. If, on the other hand, the task cannot be taken over within the common robot cell, for example, because there is only one other functional robot in addition to the malfunctioning robot, but the robot cannot take over the task of the malfunctioning robot, it is also possible for the task to be taken over by a robot in a neighboring robot cell.

The optimization takes place in real time, taking into account parameters such as the cycle time and the required energy consumption, and continues until processing by the common robot cell has been completed.

As already mentioned, machine learning algorithms can be used to optimise automatic task planning at runtime by evaluating the quality of the automatic task assignments. In addition, it is possible to learn how often different events, such as faults in particular, occur and how long they last. Based on this and other information, such as the travel time model, the decision-making process can then be automatically adapted.

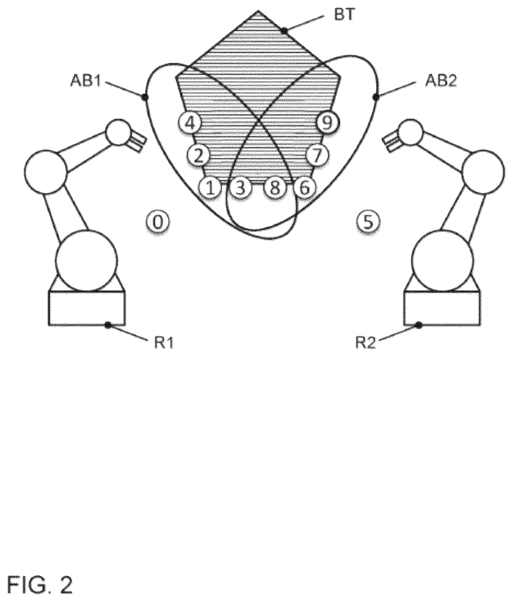

FIG. 2 schematically shows a robot cell in which the disclosed method can be carried out. This can be a welding robot cell, for example. In the example shown, two robots R1 and R2 are shown, each of which can perform tasks on a component BT in task areas AB1 and AB2, respectively. Even if only two robots are shown in the example illustrated, the robot cell can also consist of more than two robots. For example, five robots can be provided in the robot cell, four of which can perform spot welds on a component and a fifth robot checks the quality of the spot welds performed by these four robots.

In the example shown, a total of ten positions 0 to 9 are shown for the tools or grippers of the two robots when fulfilling the respective tasks, wherein robot 1 initially assumes home position 0 and robot 2 initially assumes home position 5. Tasks 1, 2, 3, 4 and 8 can be performed on the component by robot 1, and tasks 3, 6, 7, 8 and 9 by robot 2. Tasks 3 and 8 can therefore be performed by both robot 1 and robot 2. For the above-mentioned example of a welding robot cell, this can mean, for example, that the two robots in the robot cell are to perform eight spot welds at positions 1 to 4 and 6 to 9, wherein each of the two robots can weld five spots and there are two spots 3 and 8 that can be welded by both robots.

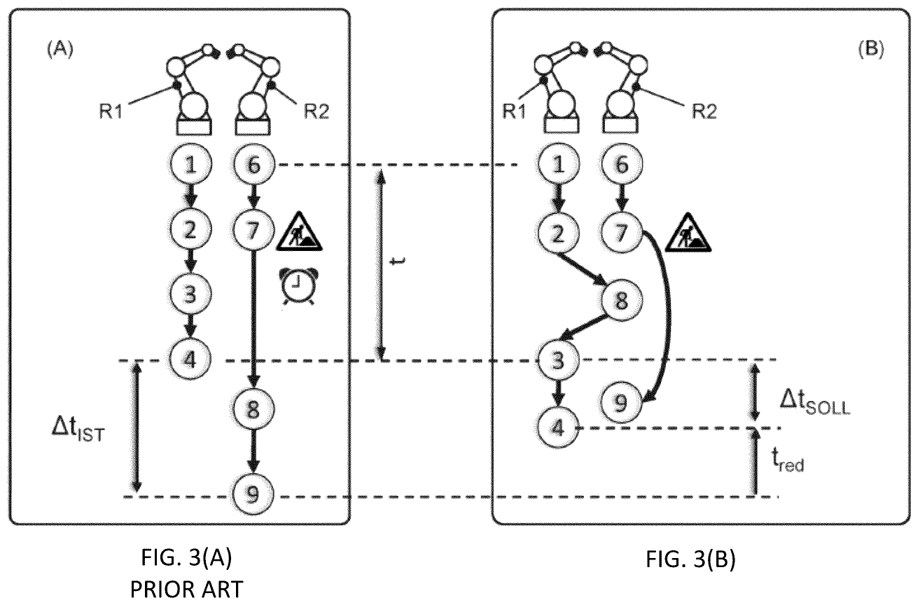

The execution of the tasks by the two robots R1 and R2, for example, the execution of the eight spot welds, is shown in sub-FIG. 3A for methods according to the prior art. In this case, robot R1 first performs the first task 1 on the component while robot R2 simultaneously performs task 6, which cannot be performed by robot R1. After the parallel execution of these two tasks by the two robots R1 and R2, robot R1 next performs task 2 and robot R2 performs task 7. If a fault now occurs at robot R2, which means that the tasks assigned to the robot can only be performed again once the fault has been rectified by repairing or replacing parts of robot R2 or replacing the entire robot R2, this may result in a significant delay ΔtIST compared to the cycle time t during fault-free operation.

For example, the failure of the welding gun of robot R2 during or immediately after spot welding 7 can mean that spot welds 8 and 9 cannot be carried out until the welding gun has been replaced.

According to the invention, this delay can be significantly reduced, as can be seen in sub-FIG. 3B. Here too, the task 1 is initially performed in parallel by robot R1 and task 6 by robot R2, and then task 2 is performed by robot R1 and task 7 by robot R2 on the component.

If a fault now occurs again at robot R2, a check is made in accordance with the disclosed embodiments as to whether one or more of the tasks not yet executed, which were originally assigned to robot R2, can also be executed by another robot in the robot cell, in this case robot R1. It is then determined that, as shown schematically in FIG. 2, tasks 3 and 8 can be performed by both robots R1 and R2. In this example, robot R1 can therefore take over task 8 from robot R2. The task 8 is now performed by robot R1 during the malfunction of robot R2. So if, in the above example, robot R2 is initially unable to carry out spot welds due to a failure of the welding gun, this can be taken over by robot R1 for the spot welds that are possible by both. Robot R1 then completes the other tasks 3 and 4. Once the fault has been rectified by robot R2, it can then complete the remaining task 9 assigned to it. Overall, although robot R1 still requires an additional amount of time ΔtSOLL to complete the new tasks compared to the cycle time t for fault-free operation, the cycle time loss is significantly reduced by the time span tred compared to the method from sub-FIG. 3A.

### LIST OF REFERENCE SIGNS

11-15 method operations
R1 robot
R2 robot
0 home position robot R1
5 home position robot R2
AB1 task area robot R1
AB2 task area robot R2
1-4, 6-9 robot tasks
BT component

1. A method for automated coordination of the activities of a plurality of robots that perform activities as a group in a common robot cell, the method comprising:
detecting scheduled tasks of the robots of the common robot cell, wherein dependencies exist among the scheduled tasks;
assigning the scheduled tasks to individual robots of the common robot cell during operation of the common robot cell;
transmitting instructions for the execution of the scheduled tasks to individual robots of the common robot cell;
recording the robot cell state during execution of the scheduled tasks; and
optimizing the execution of the scheduled tasks not yet executed during operation of the common robot cell, based on a current robot cell state and the dependencies existing among the scheduled tasks.

2. The method of claim 1, wherein at least one of the scheduled tasks is executable by a plurality of robots of the common robot cell, and wherein a task originally assigned to a first robot of the common robot cell is assigned to a second robot of the common robot cell as part of the optimisation of the execution of the scheduled tasks which have not yet been executed.

3. The method of claim 2, further comprising monitoring for identification of a fault of the first robot which results in the first robot being unable to execute the originally assigned task; and
selecting, as the second robot, another robot of the common robot cell which is capable of taking over the execution of the task assigned to the first robot, wherein the task is executed by the second robot.

4. The method of claim 1, wherein the robot cell state for the robots of the common robot cell comprises, in each case, a current position of the robot or of grippers, tools or other production components of the robot, a current task, a last processed task and/or a current operating state.

5. The method of claim 4, wherein the current operating state of a robot indicates whether the robot is currently free, is performing an assigned task, has a fault or is under repair.

6. The method of claim 1, further comprising recording a current status for each task and indicates whether the task is currently being processed, has been completed or has not yet completed.

7. The method of claim 1, further comprising recording a time required for individual robots of the common robot cell to complete the scheduled tasks during operation of the common robot cell and/or how often and under what conditions faults occur is recorded; and
adapting the assignment of the tasks to individual robots of the common robot cell accordingly.

8. The method of claim 7, further comprising predicting, based on detected faults, when a future fault of a robot is to be expected and adapting the assignment of the tasks accordingly.

9. The method of claim 1, further comprising transmitting robot control code with instructions for the execution of scheduled tasks from a task planning unit to the robots of the common robot cell by wireless radio transmission, and transmitting robot cell state data to the task planning unit by wireless radio transmission.

10. An apparatus for automated coordination of the activities of a plurality of robots performing activities as a group in a common robot cell,
wherein the apparatus detects scheduled tasks of the robots of the common robot cell, wherein dependencies exist among the scheduled tasks;
wherein the apparatus assigns the scheduled tasks to individual robots of the common robot cell during operation of the common robot cell;
wherein the apparatus transmits instructions for executing the scheduled tasks to the individual robots of the common robot cell;
wherein the apparatus records the robot cell state during the execution of the scheduled tasks; and
wherein the apparatus optimizes the execution of tasks not yet performed during operation of the common robot cell, taking into account the current robot cell state and the dependencies existing among the scheduled tasks.

11. The apparatus of claim 10, wherein at least one of the scheduled tasks is executable by a plurality of robots of the common robot cell, and wherein a task originally assigned to a first robot of the common robot cell is assigned to a second robot of the common robot cell as part of the optimisation of the execution of the scheduled tasks which have not yet been executed.

12. The apparatus of claim 11, wherein the apparatus monitors for identification of a fault of the first robot which results in the first robot being unable to execute the originally assigned task, and the apparatus selects, as the second robot, another robot of the common robot cell which is capable of taking over the execution of the task assigned to the first robot, wherein the task is executed by the second robot.

13. The apparatus of claim 10, wherein the robot cell state for the robots of the common robot cell comprises, in each case, a current position of the robot or of grippers, tools or other production components of the robot, a current task, a last processed task and/or a current operating state.

14. The apparatus of claim 13, wherein the current operating state of a robot indicates whether the robot is currently free, is performing an assigned task, has a fault or is under repair.

15. The apparatus of claim 10, wherein a current status is recorded for each task and indicates whether the task is currently being processed, has been completed or has not yet completed.

16. The apparatus of claim 10, wherein the apparatus records a time required for individual robots of the common robot cell to complete the scheduled tasks during operation of the common robot cell and/or how often and under what conditions faults occur is recorded, and the apparatus adapts the assignment of the tasks to individual robots of the common robot cell accordingly.

17. The apparatus of claim 16, wherein, based on detected faults, the apparatus predicts when a future fault of a robot is to be expected and adapting the assignment of the tasks accordingly.

18. The apparatus of claim 10, wherein the apparatus transmits robot control code with instructions for the execution of scheduled tasks from a task planning unit to the robots of the common robot cell by wireless radio transmission, and transmitting robot cell state data to the task planning unit by wireless radio transmission.

19. A production plant comprising at least one multi-robot cell and the apparatus recited in claim 10.

20. A non-transitory computer readable medium including a computer program with computer code including instructions, which when run on a computer processor, cause performance of the method recited in claim 1.
